(19) United States
(12) Patent Application Publication
(10) Pub. No.: US 2025/0121776 A1
(43) Pub. Date: Apr. 17, 2025

(54) STEP DEVICE

(71) Applicant: T-MAX (HANGZHOU) TECHNOLOGY CO., LTD., Hangzhou (CN)

(72) Inventors: Ke WANG, Hangzhou (CN); Yongyong ZHAN, Hangzhou (CN); Xinfa DU, Hangzhou (CN); Hanxin ZHANG, Hangzhou (CN); Yiming WANG, Hangzhou (CN)

(21) Appl. No.: 18/984,734

(22) Filed: Dec. 17, 2024

Related U.S. Application Data
(63) Continuation-in-part of application No. PCT/CN2023/104899, filed on Jun. 30, 2023.

(30) Foreign Application Priority Data
Dec. 8, 2022 (CN) 202211572179.9
Dec. 8, 2022 (CN) 202223298399.5

(51) Int. Cl. B60R 3/02

(52) U.S. Cl. CPC B60R 3/02

(57) ABSTRACT

A step device is provided, including a step, a limiting assembly, and a driving assembly. The step includes a fixed board and a movable board. A first end of the movable board is rotatably coupled to a first end of the fixed board, so that a second end of the movable board has a first position and a second position. In the first position, the second end of the movable board is far away from the fixed board, and a top surface of the movable board is substantially flush with a top surface of the fixed board. In the second position, at least a part of the movable board overlaps with the fixed board in a thickness direction of the fixed board. The limiting assembly is used to limit the movable board in the first position or the second position. The driving assembly is coupled to the movable board to drive the movable board to rotate relative to the fixed board.

### CROSS-REFERENCE TO RELATED APPLICATIONS

This patent document is a continuation-in-part of International Patent Application No. PCT/CN2023/104899, filed Jun. 30, 2023, which claims priority to and benefits of Chinese Patent Application Serial No. 202211572179.9 and Chinese Patent Application Serial No. 202223298399.5, both filed on Dec. 8, 2022. The entire content of the aforementioned patent applications is incorporated by reference for all purposes.

### TECHNICAL FIELD

The present disclosure relates to the field of electric steps and more particularly to a step device.

### BACKGROUND

An electric step for a vehicle is mounted to a chassis of the vehicle and can provide convenience for passengers to get on and off the vehicle. The electric step adopts an integral step, that is, a fixed step is mounted on the chassis of the vehicle. The electric step is affected by a retraction-and-extension trajectory, and a board width of the step is limited, making it difficult for passengers to find a standing place when getting on and off the vehicle, and diminishing the comfort and stability of passengers stepping on the step.

In the related art, the board width of the step is directly increased in order to improve the comfort and stability of passengers stepping on the step. However, conventional means to increase the board width of the step will cause an increase in the width of the vehicle body, which may lead to inconvenience or risk of contact when passing by another vehicle, thereby affecting the vehicle's ability to pass normally in a vehicle encounter.

### SUMMARY

The present disclosure aims to solve at least one of the problems existing in the related art to at least some extent. Accordingly, embodiments of the present disclosure propose a step device that cannot only ensure the comfort and stability of passengers getting on and off a vehicle, but also have little influence on normal passage of the vehicle. Moreover, the step device has a simple structure, is convenient to operate, and saves cost.

A step device according to embodiments of the present disclosure includes a step, a limiting assembly, and a driving assembly. The step includes a fixed board and a movable board. A first end of the movable board is rotatably coupled to a first end of the fixed board, to allow a second end of the movable board to have a first position and a second position; in the first position, the second end of the movable board is far away from the fixed board and a top surface of the movable board is substantially flush with a top surface of the fixed board; in the second position, at least a part of the movable board overlaps with the fixed board in a thickness direction of the fixed board. The limiting assembly is configured to limit movement of the movable board in the first position or the second position, e.g., which can include the limiting assembly locking the movable board in the first position or the second position. The driving assembly is coupled to the movable board to drive the movable board to rotate relative to the fixed board.

In the step device according to the embodiments of the present disclosure, the first end of the movable board is rotatably arranged at the first end of the fixed board, and the second end of the movable board has the first position and the second position. When the driving assembly drives the second end of the movable board to the first position, the top surface of the movable board is substantially flush with the top surface of the fixed board, increasing a contact area between a passenger and a top surface of the step, and making it easy for the passenger to find a standing place when getting on and off the vehicle. The contact area is an area on the top surface of the step that is available for a passenger to step on. Moreover, movement of the movable board is limited by the limiting assembly, e.g., increasing stability and thereby improving the comfort and stability of the passenger when stepping on the step. When the driving assembly drives the second end of the movable board to the second position, at least a part of the movable board overlaps with the fixed board in the thickness direction of the fixed board to reduce the contact area between the passenger and the top surface of the step, and enable the vehicle to pass by another vehicle normally and safely without contact during a driving encounter with the other vehicle. Consequently, the step device according to the embodiments of the present disclosure can adjust the contact area between the passenger and the top surface of the step by adjusting the position of the movable board relative to the fixed board, which not only achieves the comfort and stability of the passenger when stepping on the step to get on and off the vehicle, but also minimally affects normal driving of the vehicle. Furthermore, the step device has a simple structure and is convenient to operate.

In some embodiments, the limiting assembly includes a rotation wheel component and a locking member. The rotation wheel component is arranged on the fixed board; the driving assembly is coupled to the rotation wheel component to drive the rotation wheel component to rotate between a third position and a fourth position relative to the fixed board; the first end of the movable board is coupled to the rotation wheel component; and the rotation wheel component includes a first limiting groove and a second limiting groove spaced apart from each other. The locking member includes a first limiting part, a second limiting part and a pivoting part between the first limiting part and the second limiting part; the pivoting part is coupled to the fixed board; the driving assembly is coupled to the locking member to drive the pivoting part to rotate relative to the fixed board; in the third position, the first limiting part is fitted in the first limiting groove, and the second end of the movable board is in the first position; and in the fourth position, the second limiting part is fitted in the second limiting groove, and the second end of the movable board is in the second position.

In some embodiments, the rotation wheel component includes a body and a coil spring. The body is arranged on the fixed board; the driving assembly is coupled to the body to drive the body to rotate between the third position and the fourth position relative to the fixed board; the body has a cavity; the first limiting groove and the second limiting groove are arranged on the body and spaced apart from each other along a circumferential direction of the body; and the first limiting groove and the second limiting groove are in connection with the cavity. The coil spring is arranged in the cavity and configured to drive the body to rotate between the third position and the fourth position.

In some embodiments, the locking member includes a base. The pivoting part is formed in a middle position of the base, the first limiting part is formed at a first end of the base, and the second limiting part is formed at a second end of the base. The first limiting part protrudes from a first side where the base is to a second side away from the base and inclines towards the second limiting part, and the second limiting part protrudes from the first side of the base to the second side away from the base and inclines towards the first limiting part.

In some embodiments, the first side of the base is an arc-shaped surface facing the body.

In some embodiments, the driving assembly further includes: a cable, a movable anchor and a fixed anchor, a cable conduit, a cable guiding member and an elastic member. A first end of the cable is arranged in the cavity and coupled to the coil spring, and the cable is movable to drive the body to move relative to the fixed board. The movable anchor and the fixed anchor are arranged on the fixed board and spaced apart from each other; the movable anchor is movable relative to the fixed board; the movable anchor is coupled to the locking member; and the cable passes through the movable anchor and the fixed anchor and is coupled to the movable anchor. The cable conduit is fitted over the cable and located between the movable anchor and the fixed anchor. The cable guiding member is arranged on the fixed board and has an opening. The first end of the cable passes through the opening and is wound around the coil spring. The elastic member is arranged between the cable guiding member and the movable anchor and is fitted over the cable. The elastic member drives the first limiting part to fit with the first limiting groove; and a second end of the cable makes the cable be in a straight state under an action of external force, urging the cable conduit to exert force on the movable anchor, to allow the first limiting part to be separated from the first limiting groove and the second limiting part to be fitted in the second limiting groove.

In some embodiments, the cable guiding member includes a first section and a second section with an angle formed between an extension direction of the first section and an extension direction of the second section; the opening is in the first section; and the base is coupled to the second section and is rotatable relative to the second section.

In some embodiments, the driving assembly further includes a telescopic component coupled to a second end of the fixed board; the movable anchor is arranged on the body, and the fixed anchor is arranged on the telescopic component; and the telescopic component is coupled to the second end of the cable to drive the cable to move.

In some embodiments, the fixed anchor has a first perforation and a second perforation; a central axis of the first perforation coincides with a central axis of the second perforation; a diameter of the first perforation is larger than a diameter of the second perforation; an end of the cable passes through the second perforation and the first perforation in sequence; and an end of the cable conduit is in the second perforation.

In some embodiments, the driving assembly is a worm gear reducer coupled to the movable board. The worm gear reducer drives the second end of the movable board to rotate between the first position and the second position relative to the fixed board.

### BRIEF DESCRIPTION OF THE DRAWINGS

FIG. 1 is a schematic view of a step device in a closed state according to an embodiment of the present disclosure.

FIG. 2 is a schematic view of a movable board of a step device in a closed state according to an embodiment of the present disclosure.

FIG. 3 is a schematic view of a locking member and a rotation wheel component of a step device in a closed state according to an embodiment of the present disclosure.

FIG. 4 is a schematic view of a step device in an unfolded state according to an embodiment of the present disclosure.

FIG. 5 is a schematic view of a movable board of a step device in an unfolded state according to an embodiment of the present disclosure.

FIG. 6 is a schematic view of a locking member and a rotation wheel component of a step device in an unfolded state according to an embodiment of the present disclosure.

FIG. 7 is a schematic view of a fixed anchor of a step device according to an

embodiment of the present disclosure.

FIG. 8 is a schematic view of a step device in an unfolded state when the step device uses a worm gear reducer according to an embodiment of the present disclosure.

FIG. 9 is a schematic view of a step device in a closed state when the step device uses a worm gear reducer according to an embodiment of the present disclosure.

Reference numerals in the figures are identified below:
1—step; 11—fixed board; 12—movable board; 2—limiting assembly; 21—rotation wheel component; 211—body; 2111—cavity; 2112—first limiting groove; 2113—second limiting groove; 212—coil spring; 22—locking member; 221—first limiting part; 222—second limiting part; 223—pivoting part; 224—base; 3—driving assembly; 31—cable; 32—movable anchor; 33—fixed anchor; 331—first portion; 332—second portion; 3321—first perforation; 3322—second perforation; 34—cable conduit; 35—cable guiding member; 351—first section; 3511—opening; 352—second section; 36—elastic member; 37—telescopic component.

### DETAILED DESCRIPTION

Embodiments of the present disclosure will be described in detail and examples of the embodiments will be shown in the accompanying drawings. The embodiments described below with reference to the accompanying drawings are exemplary and intended to explain the present disclosure rather than limit the present disclosure.

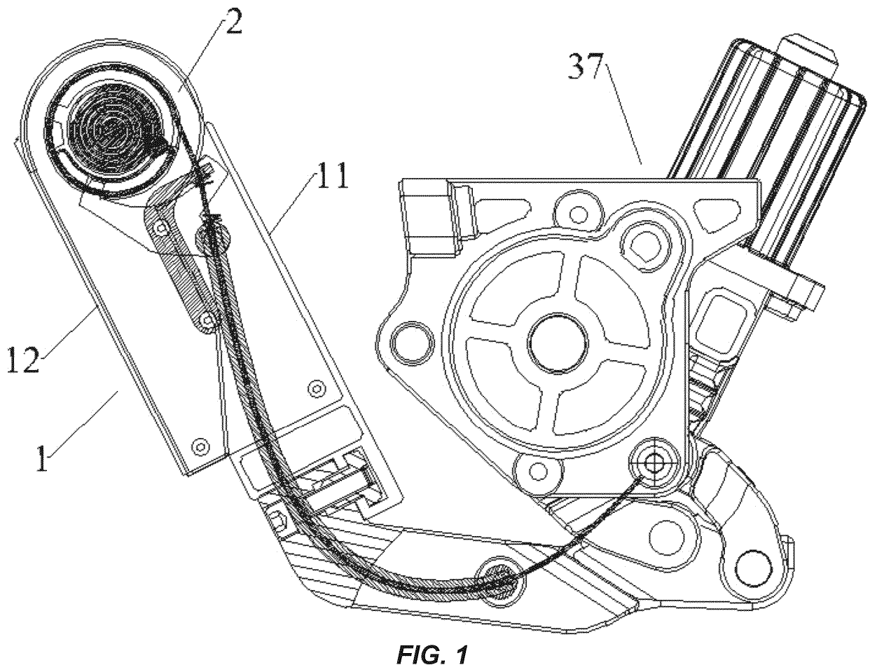

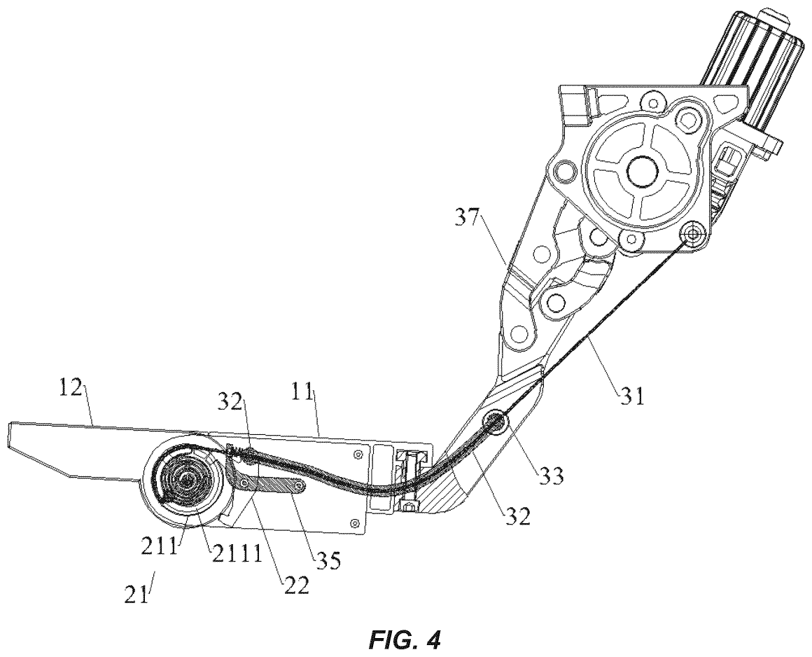

As shown in FIGS. 1-9, a step device according to embodiments of the present disclosure includes a step 1, a limiting assembly 2 and a driving assembly 3. The step 1 includes a fixed board 11 and a movable board 12. A first end of the movable board 12 (the first end of the movable board 12 as shown in FIG. 4) is rotatably coupled to a first end of the fixed board 11 (the first end of the fixed board 11 as shown in FIG. 4), so that a second end of the movable board 12 (the second end of the movable board 12 as shown in FIG. 4) has a first position and a second position. In the first position, the second end of the movable board 12 is far away from the fixed board 11, and a top surface of the movable board 12 is substantially flush with a top surface of the fixed board 11.

In some embodiments, as shown in FIG. 4, the top surface of the movable board 12 is flat. When the second end of the movable board 12 is in the first position, the top surface of the movable board 12 and the top surface of the fixed board 11 are on a common plane, which enlarges a contact area between a passenger and a top surface of the step 1, making it easy for the passenger to find a standing place when getting on and off a vehicle, and improving the stability of the passenger when stepping on the step 1.

In some embodiments, the top surface of the movable board 12 is an upward convex arc-shaped surface, so that the top surface of the movable board 12 matches a curvature of a human foot sole. When the second end of the movable board 12 is in the first position, the top surface of the movable board 12 is substantially flush with the top surface of the fixed board 11, improving the comfort of the passenger when stepping on the step 1.

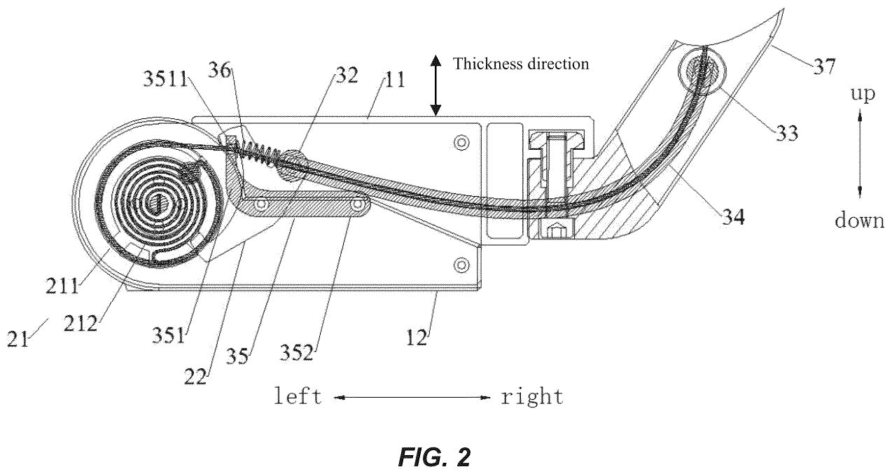

As shown in FIGS. 1 and 2, the second end of the movable board 12 is in the second position, and at least a part of the movable board 12 overlaps with the fixed board 11 in a thickness direction of the fixed board 11. In some embodiments, at least a part of the movable board 12 overlaps with the fixed board 11 in the thickness direction of the fixed board 11 to reduce the contact area between the passenger and the top surface of the step 1, so that the vehicle can still pass by another vehicle normally during a vehicle encounter.

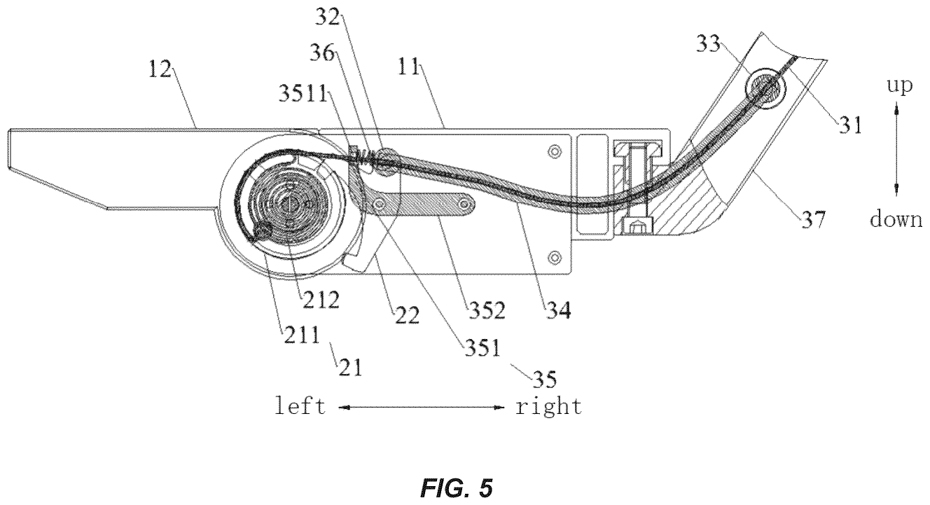

The limiting assembly 2 is used to limit the movable board 12 in the first position or the second position. The driving assembly 3 is coupled to the movable board 12 to drive the movable board 12 to rotate relative to the fixed board 11. As shown in FIGS. 4 and 5, the second end of the movable board 12 is in the first position. In some embodiments, the limiting assembly 2 limits the movable board 12 in such a way that the movable board 12 can remain in a stable state when the second end of the movable board 12 is in the first position, improving the safety of the passenger steps on the step 1, and that the stability of the movable board 12 and the fixed board 11 in an overlapping state can be ensured when the second end of the movable board 12 is in the second position, guaranteeing the safety when the vehicle is running.

Consequently, the step device according to the embodiments of the present disclosure can adjust the contact area between the passenger and the top surface of the step 1 by adjusting the position of the movable board 12 relative to the fixed board 11, which cannot only ensure the comfort and stability of the passenger getting on and off the vehicle, but also have little influence on normal driving of the vehicle. Moreover, the step device has a simple structure and is convenient to operate.

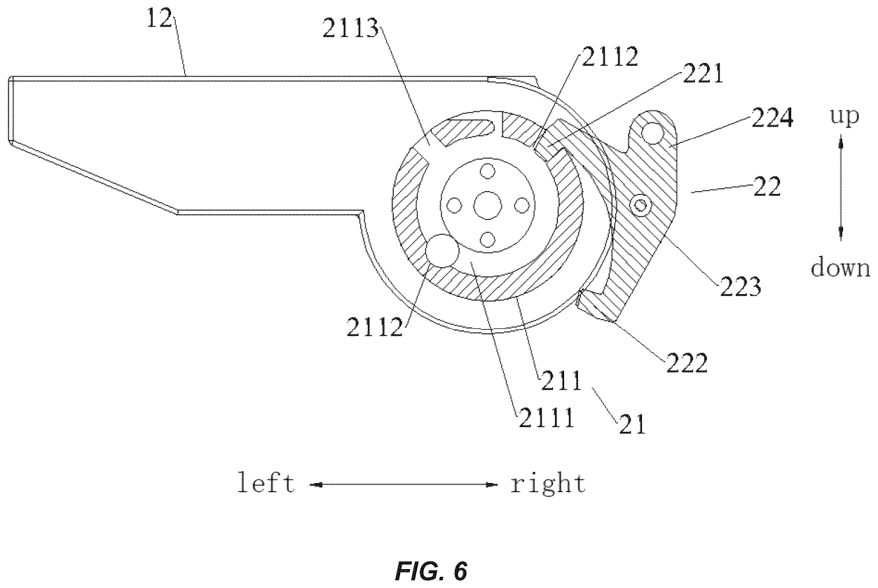

In some embodiments, as shown in FIGS. 2 and 6, the limiting assembly 2 includes a rotation wheel component 21 and a locking member 22. The rotation wheel component 21 is arranged on the fixed board 11, and the driving assembly 3 is coupled to the rotation wheel component 21 to drive the rotation wheel component 21 to rotate between the third position and the fourth position and relative to the fixed board 11. The first end of the movable board 12 is coupled to the rotation wheel component 21, and the rotation wheel component 21 has a first limiting groove 2112 and a second limiting groove 2113 spaced apart from each other.

In some embodiments, as shown in FIGS. 1 and 2, the rotation wheel component 21 is in a fourth position relative to the fixed board 11, and as shown in FIGS. 4 and 5, the rotation wheel component 21 is in a third position relative to the fixed board 11. The first end of the movable board 12 is coupled to the rotation wheel component 21, and when the driving assembly 3 drives the rotation wheel component 21 to rotate between the third position and the fourth position relative to the fixed board 11, the rotation wheel component 21 drives the movable board 12 to rotate relative to the fixed board 11, so that the second end of the movable board 12 rotates between the first position and the second position.

As shown in FIGS. 1-6, the locking member 22 has a first limiting part 221, a second limiting part 222, and a pivoting part 223 between the first limiting part 221 and the second limiting part 222. The pivoting part 223 is coupled to the fixed board 11, and the driving assembly 3 is coupled to the locking member 22 to drive the pivoting part 223 to rotate relative to the fixed board 11. In the third position, the first limiting part 221 is fitted in the first limiting groove 2112, and the second end of the movable board 12 is in the first position. In the fourth position, the second limiting part 222 is fitted in the second limiting groove 2113, and the second end of the movable board 12 is in the second position.

In some embodiments, as shown in FIGS. 4 to 6, when the driving assembly 3 drives the rotation wheel component 21 into the third position, the second end of the movable board 12 is in the first position. At this time, the first limiting groove 2112 on the rotation wheel component 21 fits with the first limiting part 221 to prevent the rotation wheel component 21 from rotating relative to the fixed board 11 due to external force, thereby ensuring that the second end of the movable board 12 is more stable when it is in the first position.

In some embodiments, as shown in FIGS. 1 to 3, when the driving assembly 3 drives the rotation wheel component 21 into the fourth position, the second end of the movable board 12 is located in the second position. At this time, the pivoting part 223 rotates relative to the fixed board 11, so that the first limiting part 221 on the rotation wheel component 21 is separated from the first limiting groove 2112, and the second limiting part 222 is fitted in the second limiting groove 2113 to prevent the rotation wheel component 21 from rotating relative to the fixed board 11 due to external force, thereby further ensuring the stability of the movable board 12 and the fixed board 11 when they are in the overlapping state and ensuring their safety when the vehicle is running.

In some embodiments, as shown in FIGS. 1-6, the rotation wheel component 21 includes a body 211 and a coil spring 212. The body 211 is arranged on the fixed board 11, and the driving assembly 3 is coupled to the body 211 to drive the main body 211 to rotate between the third position and the fourth position relative to the fixed board 11. The main body 211 has a cavity 2111, and the first limiting groove 2112 and the second limiting groove 2113 are arranged on the body 211 and spaced apart from each other along a circumferential direction of the body 211. The first limiting groove 2112 and the second limiting groove 2113 are in connection with the cavity 2111.

In some embodiments, as shown in FIGS. 1-6, the rotation wheel component 21 includes a body 211 and a coil spring 212, so that the rotation wheel component 21 has a simple structure, is easy to manufacture and saves costs. The driving assembly 3 is coupled to the body 211 to drive the body 211 to rotate between the third position and the fourth position. When the body 211 rotates, it drives the movable board 12 to rotate relative to the fixed board 11, so that the second end of the movable board 12 rotates between the first position and the second position. The first limiting groove 2112 and the second limiting groove 2113 are in connection with the cavity 2111. When the body 211 is in the third position, the first limiting part 221 can fit with the first limiting groove 2112 to maintain a stable state of the second end of the movable board 12 in the first position. When the body 211 is in the fourth position, the first limiting part 221 is separated from the first limiting groove 2112, and the second limiting part 222 fits with the second limiting groove 2113 to maintain a stable state of the second end of the movable board 12 in the second position.

As shown in FIGS. 1-6, the coil spring 212 is arranged in the cavity 2111, and the coil spring 212 is used to drive the body 211 to rotate between the third position and the fourth position. In some embodiments, the coil spring 212 is arranged in the cavity 2111, and the driving assembly 3 is coupled to the coil spring 212. When the coil spring 212 rotates counterclockwise, the driving assembly 3 is retracted counterclockwise into the cavity 2111 under the action of the coil spring 212, and the coil spring 212 rotates to the fourth position, and the second end of the movable board 12 is in the second position. At this time, the second limiting part 222 fits with the second limiting groove 2113 to keep the movable board 12 and the fixed board 11 in the stable state. When the coil spring 212 rotates clockwise, the driving assembly 3 extends out of the cavity 2111 under the action of the coil spring 212, and the coil spring 212 rotates to the third position, and the second end of the movable board 12 is in the first position. At this time, the second limiting part 222 is separated from the second limiting groove 2113, and the first limiting part 221 fits with the first limiting groove 2112, to keep the movable board 12 and the fixed board 11 in the stable state.

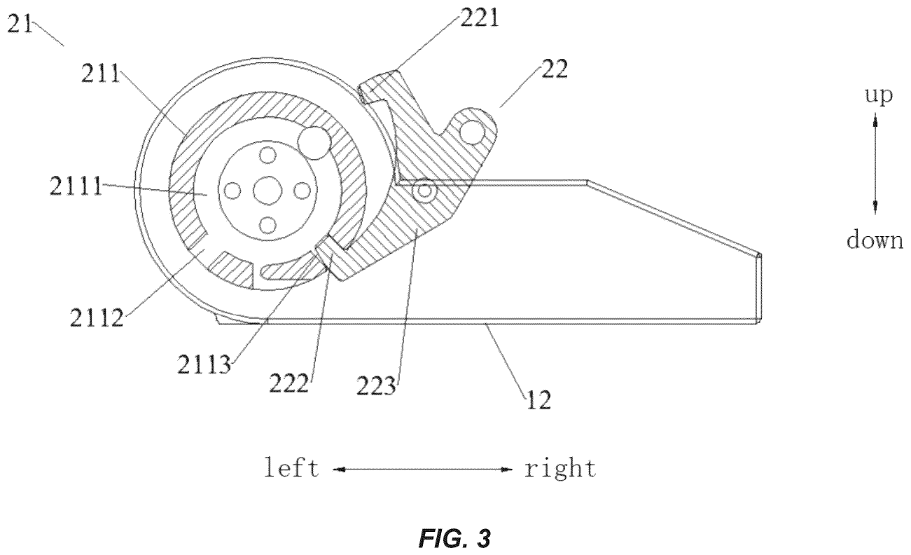

In some embodiments, as shown in FIGS. 3 and 6, the locking member 22 includes a base 224. The pivoting part 223 is formed in a middle position of the base 224; the first limiting part 221 is formed at a first end of the base 224 (an upper end of the base 224 as shown in FIG. 3); and the second limiting part 222 is formed at a second end of the base 224 (a lower end of the base 224 as shown in FIG. 3). The first limiting part 221 protrudes from a first side where the base 224 is (a side of the base 224 adjacent to the body 211 as shown in FIG. 3) to a second side away from the base 224 (a side of the base 224 away from the body 211 as shown in FIG. 3) and inclines towards the second limiting part 222. The second limiting part 222 protrudes from the first side of the base 224 to the second side away from the base 224 and inclines towards the first limiting part 221.

In some embodiments, the first limiting part 221 and the second limiting part 222 are on a side surface of the base 224 adjacent to the body 211, and the pivoting part 223 is arranged at the first end of the fixed board 11 and is rotatable relative to the fixed board 11, so that the first limiting part 221 fits with the first limiting groove 2112 when the body 211 is in the third position as shown in FIG. 6, and the first limiting part 221 is separated from the first limiting groove 2112 and the second limiting part 222 is fitted in the second limiting groove 2113 when the body 211 is in the fourth position as shown in FIG. 3.

A first end of the first limiting part 221 is coupled to the side surface of the base 224 adjacent to the body 211 and at the upper end of the base 224, and a second end of the first limiting part 221 protrudes towards a direction approaching the body 211 and inclines towards the second limiting part 222, so that the first limiting part 221 and the first limiting groove 2112 are not easily separated by external force when they are fitted with each other, further ensuring the stability of the second end of the movable board 12 in the first position.

A first end of the second limiting part 222 is coupled to the side surface of the base 224 adjacent to the body 211 and at the lower end of the base 224, and a second end of the second limiting part 222 protrudes towards the direction approaching the body 211 and inclines towards the first limiting part 221, so that the second limiting part 222 and the second limiting groove 2113 are not easily separated by external force when they are fitted with each other, further ensuring the stability of the second end of the movable board 12 in the second position.

In some embodiments, the first side of the base 224 is an arc-shaped surface facing the body 211.

In some embodiments, as shown in FIGS. 3 and 6, the side surface of the base 224 adjacent to the body 211 is an arc-shaped surface facing the body 211, so that when the first limiting part 221 is fitted with the first limiting groove 2112 or the second limiting part 222 is fitted with the second limiting groove 2113, a contact area between the side surface of the base 224 adjacent to the body 211 and an outer circumferential surface of the body 211 is increased, thereby further improving the stability when the first limiting part 221 is fitted with the first limiting groove 2112 or the second limiting part 222 is fitted with the second limiting groove 2113.

In some embodiments, as shown in FIGS. 2 and 5, the driving assembly 3 further includes a cable 31, a movable anchor 32, a fixed anchor 33, a cable conduit 34, a cable guiding member 35 and an elastic member 36. An end of the cable 31 (a left end of the cable 31 shown in FIG. 2) is arranged in the cavity 2111 and coupled to the coil spring 212. The cable 31 is movable to drive the body 211 to move relative to the fixed board 11.

In some embodiments, the left end of the cable 31 is coupled to the coil spring 212. When the coil spring 212 rotates counterclockwise, the left end of the cable 31 is retracted counterclockwise into the cavity 2111 under the action of the coil spring 212. The coil spring 212 rotates to the fourth position as shown in FIG. 2 and drives the second end of the movable board 12 to rotate to the second position, and the second limiting part 222 is fitted in the second limiting groove 2113. When the coil spring 212 rotates clockwise, the left end of the cable 31 extends out of the cavity 2111 under the action of the coil spring 212. The coil spring 212 rotates to the third position as shown in FIG. 5 and drives the second end of the movable board 12 to rotate to the first position, so that the second limiting part 222 is separated from the second limiting groove 2113, and the first limiting part 221 is fitted in the first limiting groove 2112.

As shown in FIGS. 2 and 5, the movable anchor 32 and the fixed anchor 33 are arranged on the fixed board 11 and spaced apart from each other. The movable anchor 32 is movable relative to the fixed board 11, and the movable anchor 32 is coupled to the locking member 22. The cable 31 passes through the movable anchor 32 and the fixed anchor 33, and the cable 31 is coupled to the movable anchor 32. The cable conduit 34 is fitted over the cable 31 and located between the movable anchor 32 and the fixed anchor 33. In some embodiments, the movable anchor 32 is arranged adjacent to the body 211, and a right end of the cable 31 passes through the movable anchor 32 and the fixed anchor 33 in sequence. The cable conduit 34 is arranged between the movable anchor 32 and the fixed anchor 33 and fitted over the cable 31. A right end of the cable conduit 34 is in interference fit with the fixed anchor 33, and a left end of the cable conduit 34 is coupled to the movable anchor 32, so that the left end of the cable conduit 34 is also movable relative to the fixed board 11, and the movable anchor 32 is coupled to the pivoting part 223.

As shown in FIGS. 2 and 5, the cable guiding member 35 is arranged on the fixed board 11 and has an opening 3511, and a first end of the cable 31 passes through the opening 3511 and is wound around the coil spring 212. In some embodiments, the cable guiding member 35 is arranged on a top plate, and the left end of the cable 31 passes through the opening 3511 and is wound around the coil spring 212, so that the cable 31 is not easily separated from the coil spring 212 when it is wound around the coil spring 212. The clastic member 36 is arranged between the cable guiding member 35 and the movable anchor 32 and fitted over on the cable 31, and the clastic member 36 drives the first limiting part 221 to fit with the first limiting groove 2112. A second end of the cable 31 can make the cable 31 be in a straight state under the action of external force, so as to urge the cable conduit 34 to exert force on the movable anchor 32. In such a way, the first limiting part 221 is separated from the first limiting groove 2112 and the second limiting part 222 is fitted in the second limiting groove 2113.

In some embodiments, the elastic member 36 is a spring with a simple structure and low cost.

In some embodiments, as shown in FIGS. 1-6, when the second end of the movable board 12 is in the second position, the step 1 is in a retracted state, the right end of the cable 31 is loosened, and the cable 31 rotates counterclockwise under the action of the coil spring 212 and is wound around the coil spring 212 to retract the pulling piece into the cavity 2111. At the same time, the second end of the movable board 12 is retracted below the fixed board 11, so that at least a part of the movable board 12 overlaps with the fixed board 11 in the thickness direction of the fixed board 11. Since the cable 31 is in a loosened state, the cable conduit 34 is also in a relaxed state, and the cable conduit 34 does not generate any force towards the body 211 in an extension direction of the cable 31, so that the movable anchor 32 coupled to the left end of the cable conduit 34 is not subject to any force towards the body 211, and the elastic member 36 changes from a compressed state to a stretched state and generates an elastic force, which acts on the movable anchor 32 to enable the movable anchor 32 to rotate relative to the fixed board 11. Consequently, the movable anchor 32 drives the lower end of the base 224 to rotate towards the body 211 relative to the fixed board 11, so that the first limiting part 221 is separated from the first limiting groove 2112, and the second limiting part 222 is fitted with the second limiting groove 2113 to prevent the movable board 12 from opening by itself under the action of external force.

As shown in FIGS. 1-6, when the second end of the movable board 12 is in the first position, the step 1 is in an open state, and the right end of the cable 31 is pulled. Since the second limiting part 222 and the second limiting groove 2113 fit with each other in the retracted state, the cable 31 cannot directly drive the coil spring 212 to rotate. The right end of the cable 31 is constantly pulled, forcing the cable conduit 34 to tend towards a straightened state, so that the cable conduit 34 generates a force towards the body 211 in the extension direction of the cable 31, and the movable anchor 32 coupled to the left end of the cable conduit 34 is subject to a force towards the body 211, which compresses the elastic member 36. As a result, the movable anchor 32 drives the upper end of the base 224 to rotate towards the body 211 relative to the fixed board 11, the second limiting part 222 is separated from the second limiting groove 2113, and then the coil spring 212 rotates clockwise under the action of the cable 31 to drive the body 211 to rotate from the fourth position to the third position, and the second end of the movable board 12 rotates from the second position to the first position, which allows the top surface of the movable board 12 and the top surface of the fixed board 11 to be substantially flush. At this time, the first limiting part 221 fits with the first limiting groove 2112, so that the body 211 is limited in the third position and no longer rotates, thereby preventing the movable board 12 from retracting by itself under the action of external force.

Consequently, the step device according to the embodiments of the present disclosure is easy to operate when in use, the state of the movable board 12 in the first position or the second position is stable, and the driving assembly 3 of the step device according to the embodiments of the present disclosure has a simple structure, clever cooperation among the various components of the driving assembly 3 and strong operability.

In some embodiments, as shown in FIGS. 2 and 5, the cable guiding member 35 includes a first section 351 and a second section 352, with an angle formed between an extension direction of the first section 351 and an extension direction of the second section 352. The opening 3511 is in the first section 351, and the base 224 is coupled to the second section 352 and is rotatable relative to the second section 352.

In some embodiments, the first section 351 extends in an up-down direction, the second section 352 extends in a left-right direction, and the second section 352 is arranged on the body 211. A lower end of the first section 351 is coupled to a left end of the second section 352, so that the angle is formed between the first section 351 and the second section 352. The opening 3511 is at an upper end of the first section 351, the left end of the cable 31 passes through the cable 31 and is wound around the coil spring 212, and the base 224 is coupled to the second section 352 and is rotatable relative to the fixed board 11 and the second section 352. Consequently, the structure of the cable guiding member 35 is simple, and the cable 31 is not easily separated from the coil spring 212 when it is wound around the coil spring 212.

In some embodiments, as shown in FIGS. 1 and 4, the driving assembly 3 further includes a telescopic component 37 coupled to a second end of the fixed board 11 (a right end of the movable board 12 as shown in FIG. 2). The movable anchor 32 is arranged on the body 211, the fixed anchor 33 is arranged on the telescopic component 37, and the telescopic component 37 is coupled to the second end of the cable 31 to drive the cable 31 to move.

In some embodiments, the telescopic component 37 is coupled to the second end of the fixed board 11, and the right end of the cable 31 is arranged on the telescopic component 37. The telescopic component 37 drives the right end of the cable 31 to be pulled or loosened, so that the coil spring 212 rotates between the third position and the fourth position, thereby adjusting the movable board 12 to rotate between the first position and the second position relative to the fixed board 11. Consequently, the step device according to the embodiments of the present disclosure is easy to operate when it adjusts the rotation of the movable board 12 relative to the fixed board 11, which can save time and labor.

In some embodiments, the telescopic component 37 is a four-bar linkage, a five-bar linkage, or a six-bar linkage.

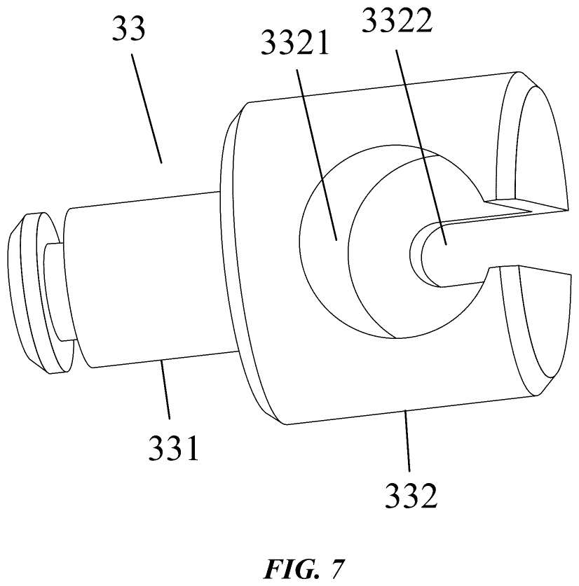

In some embodiments, as shown in FIG. 7, the fixed anchor 33 has a first perforation 3321 and a second perforation 3322. A central axis of the first perforation 3321 coincides with a central axis of the second perforation 3322, and a diameter of the first perforation 3321 is larger than a diameter of the second perforation 3322. One end of the cable 31 passes through the second perforation 3322 and the first perforation 3321 in sequence, and one end of the cable conduit 34 is located in the second perforation 3322.

In some embodiments, as shown in FIGS. 5 and 7, the fixed anchor 33 includes a first portion 331 and a second portion 332. A first end of the first portion 331 is coupled to a first end of the second portion 332, and a central axis of the first portion 331 coincides with a central axis of the second portion 332. The first portion 331 is arranged on the fixed board 11. The first perforation 3321 and the second perforation 3322 are on the second portion 332, and the first perforation 3321 and the second perforation 3322 are oppositely arranged. The central axis of the first perforation 3321 coincides with the central axis of the second perforation 3322, and the central axes of the first perforation 3321 and the second portion 332 are orthogonal to the central axis of the second portion 332. The second perforation 3322 is in connection with an end face of the second portion 332 away from the first portion 331. The diameter of the first perforation 3321 is larger than that of the second perforation 3322. The left end of the cable 31 passes through the second perforation 3322 and the first perforation 3321 in sequence. The right end of the cable conduit 34 is arranged in the first perforation 3321, and the right end of the cable conduit 34 is in interference fit with the first perforation 3321. Consequently, the fixed anchor 33 is simple in structure, easy to manufacture, and cost-effective.

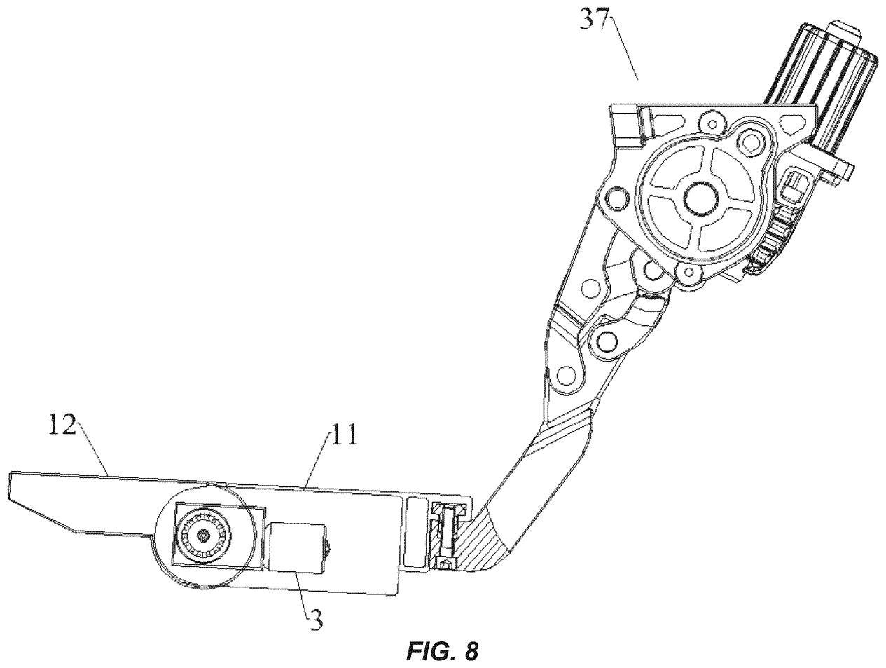

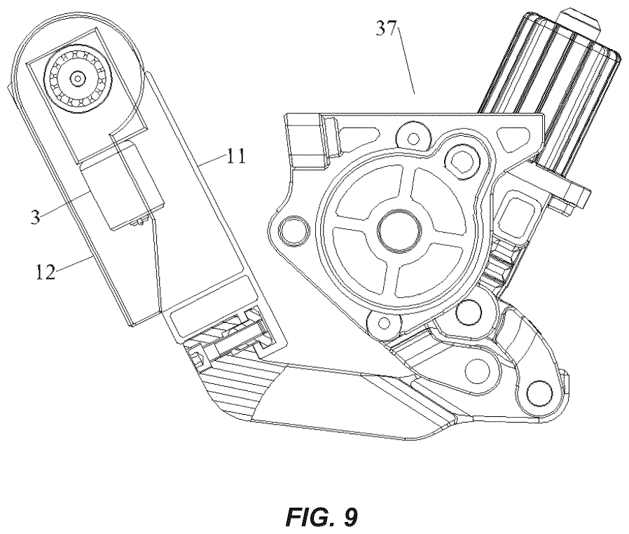

In some embodiments, as shown in FIGS. 8 and 9, the driving assembly 3 is a worm gear reducer coupled to the movable board 12, and the worm gear reducer drives the second end of the movable board 12 to rotate between the first position and the second position relative to the fixed board 11.

In some embodiments, the worm gear reducer has a self-locking function. The worm gear reducer is arranged on the fixed board 11 and coupled to the movable board 12, so that the worm gear reducer can drive the second end of the movable board 12 to rotate between the first position as shown in FIG. 8 and the second position as shown in FIG. 9. Consequently, the step device according to the embodiments of the present disclosure is simple to operate when using the worm gear reducer to drive the second end of the movable board 12 to rotate between the first position and the second position relative to the fixed board 11, and the worm gear reducer is suitable for vehicles with different chassis, thereby improving the applicability of the step device according to the embodiments of the present disclosure.

In the step device according to the embodiments of the present disclosure, the first end of the movable board is rotatably arranged at the first end of the fixed board, and the second end of the movable board has the first position and the second position. When the driving assembly drives the second end of the movable board to the first position, the top surface of the movable board is substantially flush with the top surface of the fixed board, increasing a contact area between a passenger and a top surface of the step, and making it easy for the passenger to find a standing place when getting on and off the vehicle. Moreover, the movable board is limited by the limiting assembly, improving the comfort and stability of the passenger when stepping on the step. When the driving assembly drives the second end of the movable board to the second position, at least a part of the movable board overlaps with the fixed board in the thickness direction of the fixed board, to reduce the contact area between the passenger and the top surface of the step, and enable the vehicle to pass normally during driving. Consequently, the step device according to the embodiments of the present disclosure can adjust the contact area between the passenger and the top surface of the step by adjusting the position of the movable board relative to the fixed board, which not only achieves the comfort and stability of the passenger when getting on and off the vehicle, but also has little influence on normal driving of the vehicle. Furthermore, the step device has a simple structure and is convenient to operate.

In the specification, it is to be understood that terms such as “central,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” and the like should be construed to refer to the orientation as then described or as shown in the drawings under discussion. These relative terms are for convenience and simplicity of description and do not indicate or imply that the devices or elements referred to must have a specific orientation or be constructed and operated in a specific orientation. These terms cannot be construed as limitation on the present disclosure.

In addition, terms such as “first” and “second” are used herein for purposes of description and are not intended to indicate or imply relative importance or the number of indicated technical features. Consequently, features defined as “first” and “second” can explicitly or implicitly include one or more of this feature. In the description of the present disclosure, the term “a plurality of” means at least two, such as two or three, unless specified otherwise.

In the present disclosure, unless specified or limited otherwise, terms “mounted,” “connected,” “coupled,” “fixed,” and the like are used broadly, and may be, for example, fixed connections, detachable connections, or integral connections; may also be mechanical or electrical connections; may also communicate with each other; may also be direct connections or indirect connections via intervening structures; and may also be inner connection or mutual interaction of two elements, which can be understood by those skilled in the art according to specific situations.

In the present disclosure, unless specified or limited otherwise, a structure in which a first feature is “on” or “below” a second feature may include an embodiment in which the first feature is in direct contact with the second feature and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of these phrases in various places throughout this specification are not necessarily referring to the same embodiment or example of the present disclosure. Furthermore, the particular features, structures, materials, or characteristics may be combined in any suitable manner in one or more embodiments or examples. Moreover, those skilled in the art may combine and unite different embodiments or examples described in this specification, as well as features of different embodiments or examples, without conflicting with each other.

Although embodiments of the present disclosure have been shown and described, it would be appreciated by those skilled in the art that the above embodiments are exemplary and cannot be construed as limitation on the present disclosure, and changes, modifications, alternatives, and variations can be made in the embodiments without departing from the scope of the present disclosure.

What is claimed is:

1. A step device, comprising:
a step, comprising a fixed board and a movable board, wherein a first end of the movable board is rotatably coupled to a first end of the fixed board, to allow a second end of the movable board to have a first position and a second position, wherein, in the first position, the second end of the movable board is away from the fixed board and a top surface of the movable board is substantially flush with a top surface of the fixed board, and wherein, in the second position, at least a part of the movable board overlaps with the fixed board in a thickness direction of the fixed board;
a limiting assembly, to limit movement of the movable board in the first position or the second position; and
a driving assembly, coupled to the movable board to drive the movable board to rotate relative to the fixed board.

2. The step device according to claim 1, wherein the limiting assembly comprises:
a rotation wheel component arranged on the fixed board, wherein the driving assembly is coupled to the rotation wheel component to drive the rotation wheel component to rotate between a third position and a fourth position relative to the fixed board; the first end of the movable board is coupled to the rotation wheel component; and the rotation wheel component comprises a first limiting groove and a second limiting groove spaced apart from each other; and
a locking member comprising a first limiting part, a second limiting part and a pivoting part between the first limiting part and the second limiting part, wherein the pivoting part is coupled to the fixed board; the driving assembly is coupled to the locking member to drive the pivoting part to rotate relative to the fixed board; in the third position, the first limiting part is fitted in the first limiting groove, and the second end of the movable board is in the first position; and in the fourth position, the second limiting part is fitted in the second limiting groove, and the second end of the movable board is in the second position.

3. The step device according to claim 2, wherein the rotation wheel component comprises:
a body arranged on the fixed board, wherein the driving assembly is coupled to the body to drive the body to rotate between the third position and the fourth position relative to the fixed board; the body has a cavity; the first limiting groove and the second limiting groove are arranged on the body and spaced apart from each other along a circumferential direction of the body; and the first limiting groove and the second limiting groove are in connection with the cavity; and
a coil spring arranged in the cavity and configured to drive the body to rotate between the third position and the fourth position.

4. The step device according to claim 3, wherein:
the locking member comprises a base;
wherein the pivoting part is formed in a middle position of the base, the first limiting part is formed at a first end of the base, and the second limiting part is formed at a second end of the base; and
the first limiting part protrudes from a first side where the base is to a second side away from the base and inclines towards the second limiting part, and the second limiting part protrudes from the first side of the base to the second side away from the base and inclines towards the first limiting part.

5. The step device according to claim 4, wherein the first side of the base is an arc-shaped surface facing the body.

6. The step device according to claim 4, wherein the driving assembly further comprises:
a cable, a first end of the cable being arranged in the cavity and coupled to the coil spring, and the cable being movable to drive the body to move relative to the fixed board;
a movable anchor and a fixed anchor, wherein the movable anchor and the fixed anchor are arranged on the fixed board and spaced apart from each other; the movable anchor is movable relative to the fixed board; the movable anchor is coupled to the locking member; and
the cable passes through the movable anchor and the fixed anchor and is coupled to the movable anchor;
a cable conduit fitted over the cable and located between the movable anchor and the fixed anchor;
a cable guiding member arranged on the fixed board and having an opening, wherein the first end of the cable passes through the opening and is wound around the coil spring; and
an elastic member arranged between the cable guiding member and the movable anchor and fitted over the cable, wherein the elastic member drives the first limiting part to fit with the first limiting groove; and a second end of the cable makes the cable be in a straight state under an action of external force, urging the cable conduit to exert force on the movable anchor, to allow the first limiting part to be separated from the first limiting groove and the second limiting part to be fitted in the second limiting groove.

7. The step device according to claim 6, wherein the cable guiding member comprises a first section and a second section with an angle formed between an extension direction of the first section and an extension direction of the second section; the opening is in the first section; and
the base is coupled to the second section and is rotatable relative to the second section.

8. The step device according to claim 6, wherein the driving assembly further comprises a telescopic component coupled to a second end of the fixed board,
wherein the movable anchor is arranged on the body, and the fixed anchor is arranged on the telescopic component; and the telescopic component is coupled to the second end of the cable to drive the cable to move.

9. The step device according to claim 6, wherein the fixed anchor has a first perforation and a second perforation,
wherein a central axis of the first perforation coincides with a central axis of the second perforation; a diameter of the first perforation is larger than a diameter of the second perforation; an end of the cable passes through the second perforation and the first perforation in sequence; and an end of the cable conduit is in the second perforation.

10. The step device according to claim 1, wherein the driving assembly is a worm gear reducer coupled to the movable board, wherein the worm gear reducer drives the second end of the movable board to rotate between the first position and the second position relative to the fixed board.
